(19) United States
(12) Patent Application Publication
(10) Pub. No.: US 2022/0215210 A1
(43) Pub. Date: Jul. 7, 2022

(54) INFORMATION PROCESSING APPARATUS, NON-TRANSITORY COMPUTER-READABLE STORAGE MEDIUM, AND INFORMATION PROCESSING METHOD

(71) Applicant: Mitsubishi Electric Corporation, Tokyo (JP)

(72) Inventor: Nobuaki TANAKA, Tokyo (JP)

(73) Assignee: Mitsubishi Electric Corporation, Tokyo (JP)

(21) Appl. No.: 17/703,569

(22) Filed: Mar. 24, 2022

Related U.S. Application Data
(63) Continuation of application No. PCT/JP2019/038478, filed on Sep. 30, 2019.

(51) Int. Cl. G06K 9/62; G06N 20/00

(52) U.S. Cl. CPC G06K 9/6262; G06K 9/6256; G06N 20/00; G06K 9/6261; G06K 9/6218

(57) ABSTRACT

An information processing apparatus includes a storage unit (102) that stores a feature vector set, a quality label set, and a plurality of non-quality label sets; a non-quality-label clustering unit (107) that calculates an average clustering accuracy of each of the non-quality label sets to calculate a plurality of the average clustering accuracies corresponding to the non-quality label sets, the average clustering accuracy being an average value of a clustering accuracy of clustering performed on a subset by using the quality label set, the subset being obtained by dividing the feature vectors by each of multiple elements indicated by the non-quality labels; and a processing unit (108) that generates a screen image enabling identification of at least one non-quality label type adversely affecting quality of the multiple pieces of digital data by using the average clustering accuracies.

### CROSS-REFERENCE TO RELATED APPLICATION

This application is a continuation application of International Application No. PCT/JP2019/038478 having an international filing date of Sep. 30, 2019.

### BACKGROUND OF THE INVENTION

### 1. Field of the Invention

The present invention relates to an information processing apparatus, a non-transitory computer-readable storage medium, and an information processing method.

### 2. Description of the Related Art

Advances in deep learning and related techniques have led to the popularization of systems that can perform complex recognition tasks related to images or sound. Such systems can automatically find latent structures in large volumes of learning data; and this realizes high generalization performance that could not be achieved by the classical techniques prior to deep learning.

However, such systems do not function in situations in which large volumes of labeled data are unavailable for learning. At the same time, situations are extremely rare in which large volumes of learning data are available for various real-life tasks. Therefore, the reality is that non-classical techniques such as deep learning are useless in most cases.

For example, techniques for automatically diagnosing the soundness of devices on the basis of sound and vibration generated by the devices have been studied for a long time, and various techniques have been developed. For example, the Mahalanobis-Taguchi (MT) method described in Non-Patent Literature 1 is one of the most representative methods. In the MT method, a feature space in which normal samples are distributed is preliminarily learned as a reference space, and at the time of diagnosis, normality or abnormality is determined in accordance with the divergence of an observed feature vector from the reference space.

In classical techniques, such as the MT method, appropriate restrictions can be readily applied to the models to be learned by incorporating empirical knowledge in the extraction of features and making presumptions about the distribution of feature vectors. Therefore, such methods do not require the large volume of data required for deep learning.

Non-patent Literature 1: Kazuo Tatebayashi, “nyumon taguchi mesoddo (Introduction to Taguchi Method),” JUSE Press. Ltd., 2004, pp. 167-185.

### SUMMARY OF THE INVENTION

However, classical techniques have a problem in that, although only a small volume of data is required for learning, the techniques do not function unless the quality of the data is high. However, in such a field, there are very few techniques that provide the perspective of improving the quality of measurement data. In particular, there are only a few general methods that do not require specific knowledge of the task to be performed, and in the case where the measurement data has low quality, the causes of poor data quality cannot be identified.

Accordingly, an object of at least one aspect of the present invention is to enable the identification of the cause of poor quality of the data sets to be used.

### Means of Solving the Problem

An information processing apparatus according to a first aspect of the invention includes: a storage device to store: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; and processing circuitry to calculate an average clustering accuracy of each of the non-quality label sets to calculate a plurality of the average clustering accuracies corresponding to the non-quality label sets, the average clustering accuracy being an average value of a clustering accuracy of clustering performed on a subset by using the quality label set, the subset being obtained by dividing the feature vectors by each of multiple elements indicated by the respective non-quality labels; and to generate a screen image enabling identification of at least one non-quality label type adversely affecting quality of the multiple pieces of digital data by using the average clustering accuracies.

An information processing apparatus according to a second aspect of the invention includes: a storage device to store: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; and processing circuitry to calculate, for a non-quality label set corresponding to non-quality labels of one type selected from the plurality of non-quality labels, a clustering accuracy of clustering performed on a subset by using the quality label set to calculate a plurality of the clustering accuracies, the subset being obtained by dividing the feature vectors by each of multiple elements indicated by the non-quality labels; and to generate a screen image enabling identification of at least one of the elements adversely affecting quality of the multiple pieces of digital data by using the clustering accuracies.

An information processing apparatus according to a third aspect of the invention includes: a storage device to store: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; and processing circuitry to calculate, for each of the non-quality label sets, variance of a clustering accuracy of clustering performed on a subset by using the quality label set to calculate a plurality of the variances corresponding to the non-quality label sets, the subset being obtained by dividing the feature vectors by each of multiple elements indicated by the non-quality labels; and to generate a screen image enabling identification of at least one non-quality label type adversely affecting quality of the multiple pieces of digital data by using the variances.

A non-transitory computer-readable storage medium according to a first aspect of the invention stores a program that causes a computer to execute processing including: storing: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; calculating an average clustering accuracy of each of the non-quality label sets to calculate a plurality of the average clustering accuracies corresponding to the non-quality label sets, the average clustering accuracy being an average value of a clustering accuracy of clustering performed on a subset by using the quality label set, the subset being obtained by dividing the feature vectors by each of multiple elements indicated by the respective non-quality labels; and generating a screen image enabling identification of at least one non-quality label type adversely affecting quality of the multiple pieces of digital data by using the average clustering accuracies.

A non-transitory computer-readable storage medium according to a second aspect of the invention stores a program that causes a computer to execute processing including: storing: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; calculating, for a non-quality label set corresponding to non-quality labels of one type selected from the plurality of non-quality labels, a clustering accuracy of clustering performed on a subset by using the quality label set to calculate a plurality of the clustering accuracies, the subset being obtained by dividing the feature vectors by each of multiple elements indicated by the non-quality labels; and generating a screen image enabling identification of at least one of the elements adversely affecting quality of the multiple pieces of digital data by using the clustering accuracies.

A non-transitory computer-readable storage medium according to a third aspect of the invention stores a program that causes a computer to execute processing including: storing: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; calculating, for each of the non-quality label sets, variance of a clustering accuracy of clustering performed on a subset by using the quality label set to calculate a plurality of the variances corresponding to the non-quality label sets, the subset being obtained by dividing the feature vectors by each of multiple elements indicated by the non-quality labels; and generating a screen image enabling identification of at least one non-quality label type adversely affecting quality of the multiple pieces of digital data by using the variances.

An information processing method according to a first aspect of the invention includes: storing: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; calculating an average clustering accuracy of each of the non-quality label sets to calculate a plurality of the average clustering accuracies corresponding to the non-quality label sets, the average clustering accuracy being an average value of a clustering accuracy of clustering performed on a subset by using the quality label set, the subset being obtained by dividing the feature vectors by each of multiple elements indicated by the respective non-quality labels; and generating a screen image enabling identification of at least one non-quality label type adversely affecting quality of the multiple pieces of digital data by using the average clustering accuracies.

An information processing method according to a second aspect of the invention includes: storing: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; calculating, for a non-quality label set corresponding to non-quality labels of one type selected from the plurality of non-quality labels, a clustering accuracy of clustering performed on a subset by using the quality label set to calculate a plurality of the clustering accuracies, the subset being obtained by dividing the feature vectors by each of multiple elements indicated by the non-quality labels; and generating a screen image enabling identification of at least one of the elements adversely affecting quality of the multiple pieces of digital data by using the clustering accuracies.

An information processing method according to a third aspect of the invention includes: storing: a feature vector set including a plurality of feature vectors generated by extracting a predetermined feature from each of multiple pieces of digital data indicating measurement values obtained by measuring a target; a quality label set including a plurality of quality labels corresponding to the multiple pieces of digital data and indicating quality of the target; and a plurality of non-quality label sets each including a plurality of non-quality labels, the non-quality labels corresponding to the multiple pieces of digital data and being of a type expected to be independent of the quality of the target; calculating, for each of the non-quality label sets, variance of a clustering accuracy of clustering performed on a subset by using the quality label set to calculate a plurality of the variances corresponding to the non-quality label sets, the subset being obtained by dividing the feature vectors by each of multiple elements indicated by the non-quality labels; and generating a screen image enabling identification of at least one non-quality label type adversely affecting quality of the multiple pieces of digital data by using the variances.

According to one or more aspects of the present invention, the cause of the poor quality of the data set to be used can be identified.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating the configuration of an information processing apparatus according to a first embodiment;

FIG. 2 is a block diagram schematically illustrating a usage example of the information processing apparatus according to the first embodiment;

FIGS. 3A to 3C are graphs for explaining the accuracy of subset-by-subset clustering and overall clustering for a non-quality label for inspector;

FIG. 4 is a graph for explaining clustering accuracy for the data as a whole when heterogeneity due to differences in inspectors is eliminated through a certain method;

FIGS. 5A and 5B are block diagrams illustrating hardware configuration examples;

FIG. 6 is a flowchart illustrating processing by the information processing apparatus to display a label-type evaluation screen image;

FIG. 7 is a flowchart illustrating processing by the information processing apparatus to display an accuracy-improvement-amount screen image; and

FIG. 8 is a flowchart illustrating processing by the information processing apparatus to display an accuracy-influence-element evaluation screen image.

### DETAILED DESCRIPTION OF THE INVENTION

In the following embodiments, a case will be described in which the soundness of a motor that is a target is determined on the basis of the vibration of the motor.

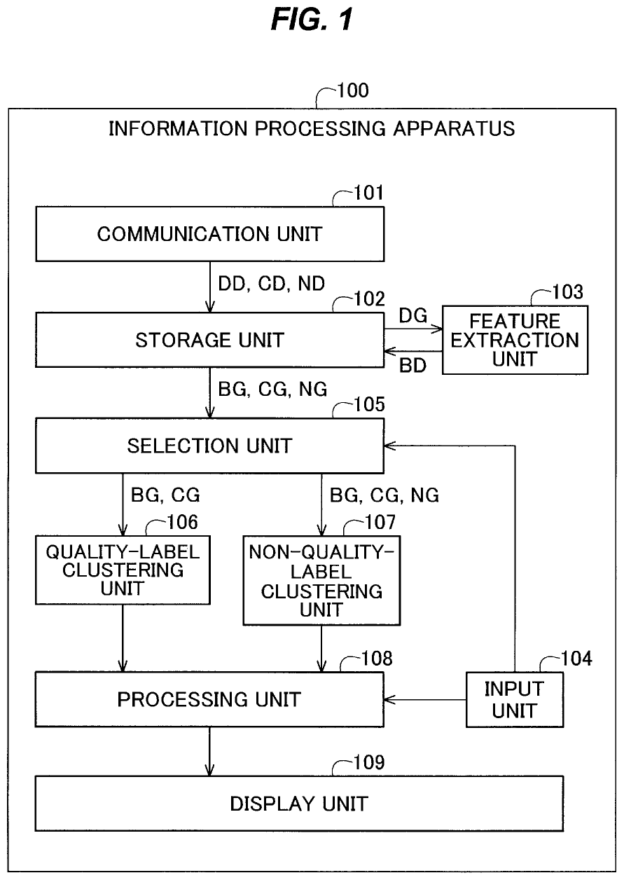

FIG. 1 is a block diagram schematically illustrating the configuration of an information processing apparatus 100 according to a first embodiment.

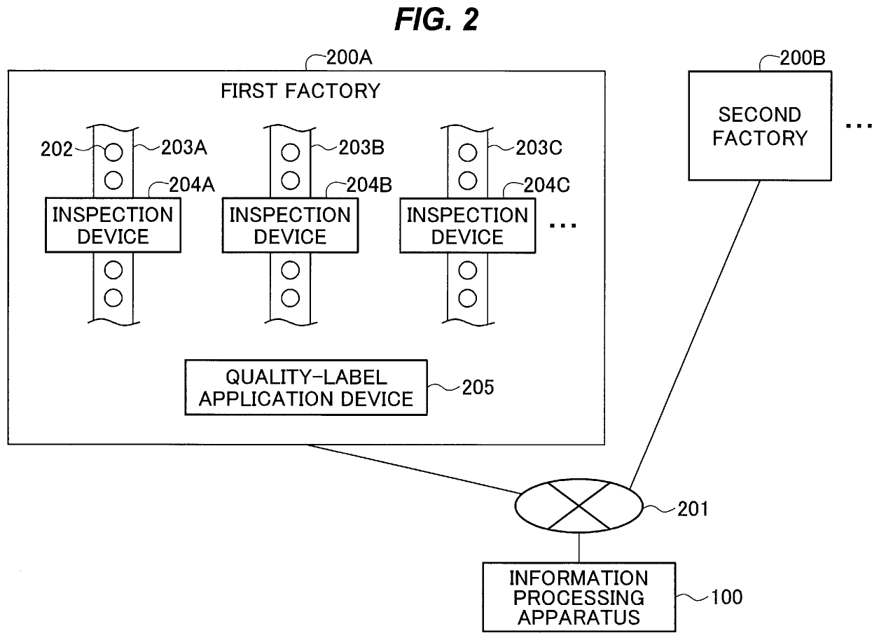

FIG. 2 is a block diagram schematically illustrating a usage example of the information processing apparatus 100 according to the first embodiment.

As illustrated in FIG. 2, for example, the information processing apparatus 100 is connected to bases, such as a first factory 200A, a second factory 200B, . . . , located at different sites, via a network 201, such as the Internet.

Since the factories, such as the first factory 200A, the second factory 200B, . . . , manufacture motors that are targets with the same facility equipment, and the contents of the connections with the information processing apparatus 100 are also the same, the first factory 200A will be described below.

The first factory 200A includes a plurality of manufacturing lines 203A, 203B, 203C, . . . for manufacturing motors 202.

The inspectors assigned to the respective manufacturing lines 203A, 203B, 203C, . . . inspect the motors 202 manufactured in the manufacturing lines 203A, 203B, 203C, . . . by respectively using inspection devices 204A, 204B, 204C, . . . located in the manufacturing lines 203A, 203B, 203C, . . . , respectively.

For example, the inspection devices 204A, 204B, 204C, . . . measure the amplitudes of vibration generated while the motors 202 are driven and generate digital data DD including motor numbers that are motor identification information for identifying the motors 202 that have been inspected and inspection data indicating the measurement values or amplitudes.

The respective inspection devices 204A, 204B, 204C, . . . generate non-quality label data ND indicating the motor numbers of the motors 202 that have been inspected, the data numbers of the digital data DD acquired in the inspection, and non-quality labels of types expected to be independent of the quality of the motors 202. Note that in this embodiment, each of the inspection devices 204A, 204B, 204C, . . . generates non-quality label data ND including non-quality labels of multiple types.

Here, it is presumed that the non-quality label types include inspector, date and time, manufacturing line, location, and inspection device.

The non-quality label for inspector includes, as an element, an inspector number, which is inspector identification information for identifying an inspector.

The non-quality label for date and time includes, as an element, measurement date and time, which are the date and time of when the inspection has been performed.

The non-quality label for manufacturing line includes, as an element, a line number, which is line identification information for identifying a manufacturing line.

The non-quality label for location includes, as an element, a location ID, which is factory identification information used to identify a factory.

The non-quality label for inspection device includes, as an element, a device number, which is an inspection device identification number for identifying an inspection device.

Specifically, generated are first non-quality label data ND#1 indicating the motor number of the motor 202 that has been inspected, the data number of the digital data DD acquired through the inspection, and the inspector number of the inspector who has performed the inspection; second non-quality label data ND#2 indicating the motor number of the motor 202 that has been inspected, the data number of the digital data DD acquired through the inspection, and the measurement date and time at which the inspection has been performed; third non-quality label data ND#3 indicating the motor number of the motor 202 that has been inspected, the data number of the digital data DD acquired through the inspection, and the line number of the manufacturing line on which the motor 202 has been manufactured; fourth non-quality label data ND#4 indicating the motor number of the motor 202 that has been inspected, the data number of the digital data DD acquired through the inspection, and the location ID of the factory at which the motor 202 has been manufactured; fifth non-quality label data ND#5 indicating the motor number of the motor 202 that has been inspected, the data number of the digital data DD acquired through the inspection, and the device number of the inspection device that has performed the inspection on the motor 202; and the like.

Note that it is presumed that each piece of the non-quality label data ND includes information indicating the corresponding non-quality label type.

Each of the inspection devices 204A, 204B, 204C, . . . , sends the corresponding digital data DD and the non-quality label data ND generated as described above to the information processing apparatus 100 via the network 201.

Note that the non-quality labels are labels of types that are expected to be independent of quality. In other words, a non-quality label is a label of a type that the quality controller anticipates not to reflect quality. Here, since it is desired that the quality of the motor 202 not be affected by the inspector, the date and time, the manufacturing line, the location, and the inspection device, labeling is performed for the following types: inspector, date and time, manufacturing line, location, and inspection device.

The first factory 200A is provided with a quality-label application device 205.

For example, the motor 202 manufactured in the first factory 200A is subjected to a final inspection by an experienced inspector or the like, and the inspection result, which is a normal or, abnormal result, and the motor number of the inspected motor 202 are input to the quality-label application device 205.

The quality-label application device 205 generates quality label data CD indicating the input motor number and the normal or abnormal result, and sends the generated quality label data CD to the information processing apparatus 100 via the network 201. Here, the quality label is a label indicating quality (here, normal or abnormal).

The information processing apparatus 100 receives the digital data DD, the quality label data CD, and the non-quality label data ND sent as described above, and performs processing.

As illustrated in FIG. 1, the information processing apparatus 100 includes a communication unit 101, a storage unit 102, a feature extraction unit 103, an input unit 104, a selection unit 105, a quality-label clustering unit 106, a non-quality-label clustering unit 107, a processing unit 108, and a display unit 109.

The communication unit 101 communicates with the network 201. For example, the communication unit 101 receives multiple pieces of digital data DD, multiple pieces of quality label data CD, and multiple pieces of non-quality label data ND from multiple factories via the network 201.

The storage unit 102 stores data and programs necessary for processing by the information processing apparatus 100. For example, the storage unit 102 stores the multiple pieces of digital data DD, the multiple pieces of quality label data CD, and the multiple pieces of non-quality label data ND received by the communication unit 101 as a digital data set DG, a quality label set CG, and a non-quality label set NG, respectively.

As described below, the storage unit 102 stores a feature vector set BG generated by the feature extraction unit 103.

Note that in this embodiment, for example, the first non-quality label data ND#1 to the fifth non-quality label data ND#5 corresponding to the non-quality label types are stored as the non-quality label data ND.

The feature extraction unit 103 reads the digital data set DG stored in a storage unit 102, extracts predetermined features from the inspection data included in the digital data DD in the read digital data set DG, and generates feature vector data BD indicating the extracted features and the motor numbers included in the digital data DD. The feature extraction unit 103 then stores multiple pieces of feature vector data BD as a feature vector set BG in a storage unit 102. Examples of techniques of extracting features from inspection data include filter bank analysis, wavelet analysis, linear predictive coding (LPC) analysis, and cepstrum analysis. The extracted features are represented by feature vectors.

The input unit 104 accepts input of an instruction from an operator of the information processing apparatus 100.

For example, the input unit 104 accepts input of selection of the processing mode. In this embodiment, the processing modes are a label-type evaluation mode, an accuracy-improvement-amount calculation mode, and an accuracy-influence-element evaluation mode.

Note that when the accuracy-influence-element evaluation mode is selected, the input unit 104 also accepts an input of the non-quality label type for evaluating an element affecting accuracy.

The input unit 104 then notifies the selection unit 105 and the processing unit 108 of the input processing mode and the selected non-quality label type when the accuracy-influence-element evaluation mode is selected.

The selection unit 105 selects and reads the data stored in the storage unit 102 in accordance with the selection input to the input unit 104.

For example, when the label-type evaluation mode is selected, the selection unit 105 reads the feature vector set BG, the quality label set CG, and the non-quality label sets NG of all types from the storage unit 102, and feeds the read data to the non-quality-label clustering unit 107.

When the accuracy-improvement-amount calculation mode is selected, the selection unit 105 reads the feature vector set BG and the quality label set CG from the storage unit 102 and feeds the read data to the quality-label clustering unit 106, and the selection unit 105 also reads the feature vector set BG, the quality label set CG, and the non-quality label sets NG of all types from the storage unit 102, and feeds the read data to the non-quality-label clustering unit 107.

When the accuracy-influence-element evaluation mode is selected, the selection unit 105 reads the feature vector set BG, the quality label set CG, and the non-quality label set NG corresponding to the type of the non-quality label selected with the input unit 104 from the storage unit 102, and feeds the read data to the non-quality-label clustering unit 107.

The quality-label clustering unit 106 executes clustering on the basis of the feature vector set BG fed from the selection unit 105, and compares the quality determination results (e.g., normal or abnormal) by the clustering with the inspection results (e.g., normal or abnormal) indicated by the quality label set CG to calculate clustering accuracy. The clustering accuracy calculated here is also referred to as reference clustering accuracy.

The clustering accuracy is the success rate of clustering or the failure rate of clustering.

In this embodiment, the clustering accuracy is the accuracy rate of the quality determination result by clustering to the inspection result indicated in the quality label set CG, but this embodiment is not limited to such an example.

For example, the clustering accuracy may be an error rate, an F-value, a true positive rate (TPR), or a true negative rate (TNR) of the quality determination result by clustering to the inspection result indicated in the quality label set CG.

When the non-quality-label clustering unit 107 receives non-quality label sets NG of all types of non-quality labels from the selection unit 105, the non-quality-label clustering unit 107 divides the feature vector data BD included in the feature vector set BG fed from the selection unit 105 into subsets of the respective elements of the non-quality labels of the respective types of the non-quality label sets NG. For example, when the non-quality label set NG is of an inspector number type, the feature vector data BD included in the feature vector set BG is divided by each inspector number.

The non-quality-label clustering unit 107 then executes clustering on the basis of the divided feature vector data BD, compares the quality determination results by the clustering with the inspection results indicated by the quality label set CG, and calculates the clustering accuracy for each subset (i.e., for each element). The non-quality-label clustering unit 107 then calculates the average clustering accuracy that is the average value of the clustering accuracies calculated for the respective subsets for each non-quality label type.

In other words, in the label-type evaluation mode and the accuracy-improvement-amount calculation mode, the non-quality-label clustering unit 107 calculates the average clustering accuracy of each non-quality label type, and feeds the calculated average clustering accuracies to the processing unit 108.

When the non-quality-label clustering unit 107 receives a non-quality label set NG of one type of non-quality labels from the selection unit 105, the non-quality-label clustering unit 107 divides the feature vector data BD included in the feature vector set BG fed from the selection unit 105 into subsets for the respective elements of one type of non-quality labels indicated in the non-quality label set NG.

The non-quality-label clustering unit 107 then executes clustering on the basis of the divided feature vector data BD, compares the quality determination results by the clustering with the inspection results'indicated by the quality label set CG, and calculates the clustering accuracy for each subset (i.e., for each element).

In other words, in the accuracy-influence-element evaluation mode, the non-quality-label clustering unit 107 calculates clustering accuracy for each subset for the selected non-quality label type, and feeds the clustering accuracy calculated for each subset to the processing unit 108.

The processing unit 108 performs processing in accordance with the processing mode input accepted by the input unit 104 by using the clustering accuracies calculated by the quality-label clustering unit 106 and/or the average clustering accuracies calculated by the non-quality-label clustering unit 107.

Here, the processing unit 108 generates a screen image that enables identification of at least one non-quality label type that is adversely affecting the quality of multiple pieces of digital data DD by using multiple average clustering accuracies, or a screen image that enables identification of at least one element that is adversely affecting the quality of the multiple pieces of digital data DD by using multiple clustering accuracies.

For example, in the label-type evaluation mode, the processing unit 108 generates a label-type evaluation screen image for displaying at least some of the non-quality label types, together with the average clustering accuracies, in a descending order of average clustering accuracy.

In the accuracy-improvement-amount calculation mode, the processing unit 108 subtracts the clustering accuracy calculated by the quality-label clustering unit 106 from each of the average clustering accuracies calculated by the non-quality-label clustering unit 107 to calculate an improvement amount of clustering accuracy for each non-quality label type. The processing unit 108 then generates an accuracy-improvement-amount screen image indicating at least some of the non-quality label types and the improvement amounts calculated correspondingly.

In the accuracy-influence-element evaluation mode, the processing unit 108 generates an accuracy-influence-element evaluation screen image indicating at least some of the corresponding elements, together with their clustering accuracies, in an ascending order of clustering accuracy for the respective subsets of one non-quality label type calculated by the non-quality-label clustering unit 107.

The display unit 109 displays various screen images. For example, the display unit 109 displays the label-type evaluation screen image, the accuracy-improvement-amount screen image, or the accuracy-influence-element evaluation screen image generated by the processing unit 108.

The basic concept of the processing by the information processing apparatus 100 will now be described.

When a feature vector is divided by a non-quality label that is expected to be independent of quality and clustering is performed on each divided subset, the average clustering accuracy is expected to be higher than that of when similar clustering is performed on the data set as a whole.

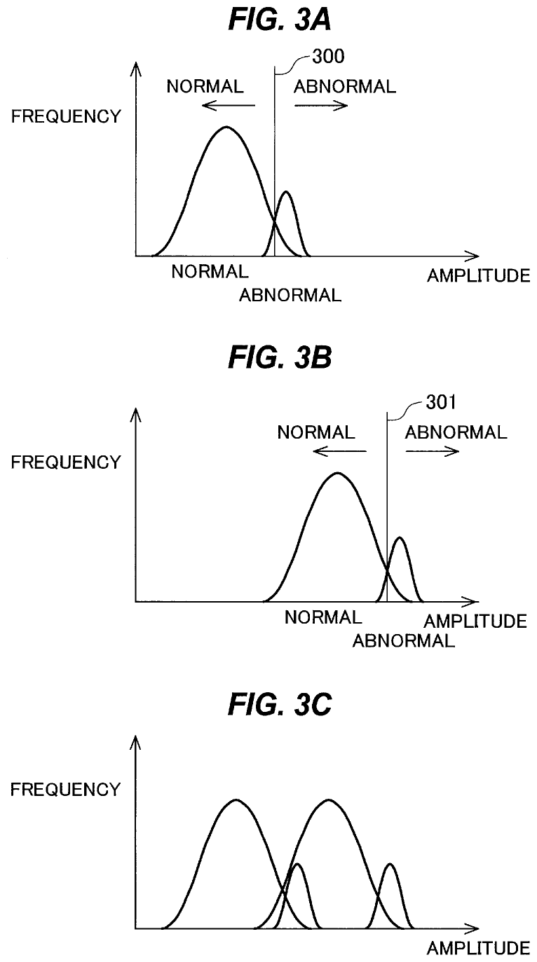

FIGS. 3A to 3C are graphs for explaining the accuracy of subset-by-subset clustering and the overall clustering for a non-quality label for inspector.

For example, FIG. 3A is a graph plotting a histogram of the normality and abnormality of a motor 202 based on the inspection data measured by an inspector A.

Similarly, FIG. 3B is a graph plotting a histogram of the normality and abnormality of a motor 202 based on the inspection data measured by an inspector B.

FIG. 3C is a graph in which the histogram illustrated in FIG. 3A and the histogram illustrated in FIG. 3B are displayed in a superimposed manner.

As illustrated in FIG. 3C, the distribution of the abnormality data measured by the inspector A overlaps the distribution of the normality data measured by the inspector B, and this suggests that clustering of the normality and abnormality cannot be performed with high accuracy on the data as a whole.

However, as illustrated in FIG. 3A, when only the data of the inspector A is considered, clustering of the normality and abnormality is possible by setting a boundary 300 for determining the normality and the abnormality. Similarly, as illustrated in FIG. 3B, also for the data of the inspector B, clustering of the normality and abnormality is possible by setting a boundary 301 for determining the normality and the abnormality.

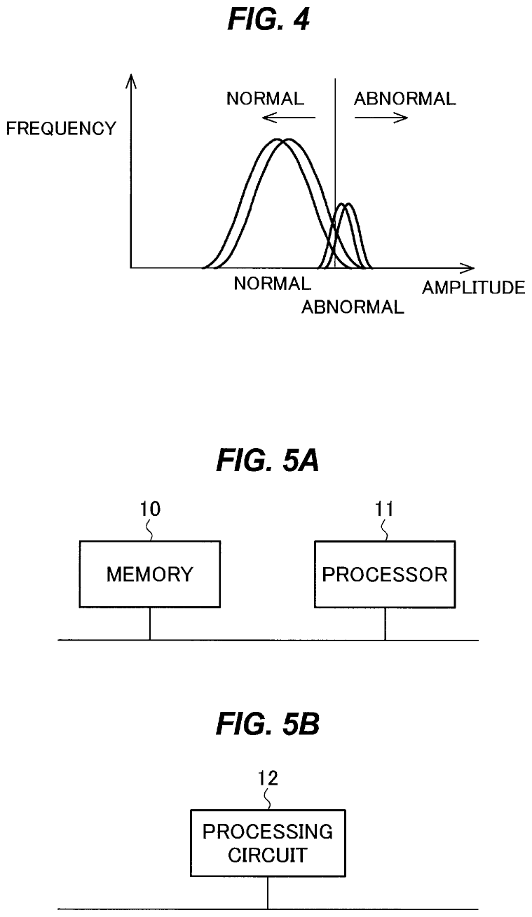

At this time, as illustrated in FIG. 4, the average clustering accuracy of the clustering on the individual subsets of the inspectors as described above can be expected to match the clustering accuracy for the data as a whole when the heterogeneity caused by the difference of the inspectors is eliminated in some way. Therefore, the average clustering accuracy of clustering for individual subsets of the inspectors can be used as an expected value of the accuracy obtained when the heterogeneity caused by the difference of the measurers can be eliminated.

As described above, by arranging the non-quality label types in a descending order of average clustering accuracy in the label-type evaluation screen image, it is possible to grasp a factor that is capable of enhancing the clustering accuracy by reducing the variation in the acquisition method for acquiring the inspection data, i.e., the cause of the low clustering accuracy of the data as a whole. That is, it is possible to grasp that a non-quality label type having higher average clustering accuracy has a greater effect on the quality of the inspection data and has a higher possibility of being the cause of an adverse effect on the quality of the inspection data.

By displaying the improvement amount of the clustering accuracy together with the non-quality label types in the accuracy-improvement-amount screen image, it is possible to grasp how much the overall clustering accuracy can be improved by improving the acquisition method for acquiring the inspection data in some way for the respective non-quality label types. In this case, also, it can be estimated that what has a larger improvement amount of the clustering accuracy is being the cause of the decrease in the clustering accuracy of the data as a whole. That is, it can be grasped that the non-quality label type of which the improvement amount of clustering accuracy is large has a great effect on the quality of the inspection data and has a higher possibility of being the cause of an adverse effect on the quality of the inspection data.

Furthermore, by indicating the corresponding elements together with their clustering accuracies in the accuracy-influence-element evaluation screen image, it is possible to grasp which element requires an improved acquisition method when the inspection data is acquired. In this case, also, the element that is lowering the clustering accuracy of the data as a whole can be identified. That is, it can be grasped that an element having lower clustering accuracy has a greater effect on the quality of the inspection data and thus has a higher possibility of being the cause of an adverse effect on the quality of the inspection data.

A portion or the entirety of the feature extraction unit 103, the selection unit 105, the quality-label clustering unit 106, the non-quality-label clustering unit 107, and the processing unit 108 described above can be implemented by, for example, a memory 10 and a processor 11, such as a central processing unit (CPU), that executes the programs stored in the memory 10, as illustrated in FIG. 5A. Such programs may be provided via a network or may be recorded and provided on a recording medium, such a non-transitory computer-readable storage medium. That is, such programs may be provided as, for example, program products.

Furthermore, a portion or the entirety of the feature extraction unit 103, the selection unit 105, the quality-label clustering unit 106, the non-quality-label clustering unit 107, and the processing unit 108 can be implemented by, for example, a processing circuit 12, such as a single circuit, a composite circuit, a programmed processor, a parallel programmed processor, an application-specific integrated circuit (ASIC), or a field programmable gate array (FPGA), as illustrated in FIG. 5B.

In other words, the feature extraction unit 103, the selection unit 105, the quality-label clustering unit 106, the non-quality-label clustering unit 107, and the processing unit 108 can be implemented by processing circuitry.

Note that the communication unit 101 can be implemented by a communication device, such as a network interface card (NIC).

Note that the storage unit 102 can be implemented by a storage device, such as a hard disk drive (HDD).

The input unit 104 can be implemented by an input device, such as a mouse or a keyboard.

The display unit 109 can be implemented by a display device, such as a liquid crystal display.

As described above, the information processing apparatus 100 can be implemented by a computer.

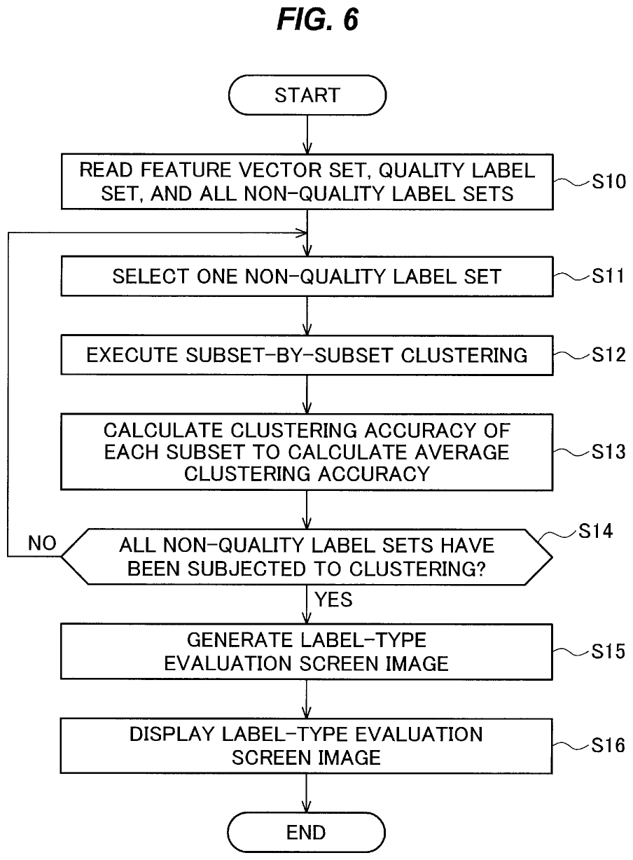

FIG. 6 is a flowchart illustrating the processing by the information processing apparatus 100 to display a label-type evaluation screen image.

The flowchart illustrated in FIG. 6 starts, for example, when an operator of the information processing apparatus 100 inputs an instruction to the input unit 104 to select the label-type evaluation mode. In such a case, the input unit 104 notifies the selection unit 105 and the processing unit 108 that the label-type evaluation mode has been selected.

First, the selection unit 105 reads the feature vector set BG, the quality label set CG, and the non-quality label sets NG corresponding to the non-quality labels of all types stored in the storage unit 102, and feeds the read data to the non-quality-label clustering unit 107 (step S10).

The non-quality-label clustering unit 107 then selects a non-quality label set NG corresponding to one of non-quality labels not yet subjected to clustering out of the non-quality label sets NG received from the selection unit 105 (step S11).

The non-quality-label clustering unit 107 then divides the feature vector set BG fed from the selection unit 105 into subsets for the respective elements of the non-quality label indicated by the selected non-quality label set NG, and executes clustering on each divided subset (step S12).

The non-quality-label clustering unit 107 then compares the quality determination result by the clustering executed in step S12 with the inspection result indicated by the quality label set CG, calculates the clustering accuracies for the respective subsets, and calculates the average value or the average clustering accuracy (step S13). The calculated average clustering accuracy is reported to the processing unit 108 together with the non-quality label type.

The non-quality-label clustering unit 107 then determines whether or not the non-quality label sets NG corresponding to the non-quality labels of all types have been subjected to clustering (step S14). If the non-quality label sets NG of all types have been subjected to clustering (Yes in step S14), the processing proceeds to step S15, and if there are non-quality label sets NG of any type that have not yet been subjected to clustering (No in step S14), the processing returns to step S11.

In step S15, the processing unit 108 generates a label-type evaluation screen image for displaying at least some of the non-quality label types, together with their average clustering accuracies, in a descending order of average clustering accuracy calculated by the non-quality-label clustering unit 107 (step S15).

The display unit 109 then displays the label-type evaluation screen image generated by the processing unit 108 (step S16).

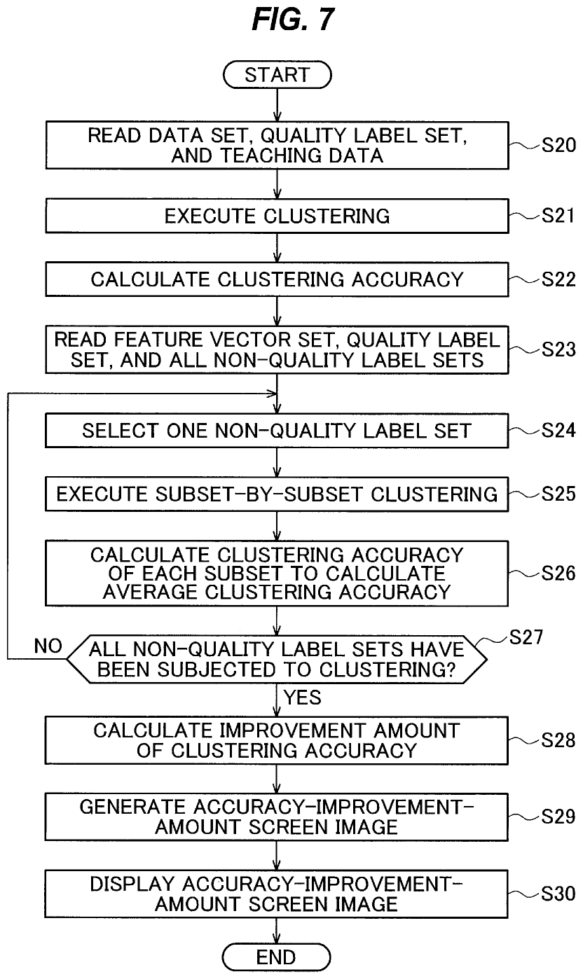

FIG. 7 is a flowchart illustrating the processing by the information processing apparatus 100 to display an accuracy-improvement-amount screen image.

The flowchart illustrated in FIG. 7 starts, for example, when an operator of the information processing apparatus 100 inputs an instruction to the input unit 104 to select the accuracy-improvement-amount calculation mode. In such a case, the input unit 104 notifies the selection unit 105 and the processing unit 108 that the accuracy-improvement-amount calculation mode has been selected.

First, the selection unit 105 reads the feature vector set BG and the quality label set CG from the storage unit 102, and feeds the read data to the quality-label clustering unit 106 (step S20).

The quality-label clustering unit 106 then executes clustering based on the feature vector set BG fed from the selection unit 105 (step S21).

The quality-label clustering unit 106 then compares the quality determination result by the clustering performed in step S21 with the inspection result indicated by the quality label set CG to calculate clustering accuracy (step S22). The clustering accuracy calculated here is fed to the processing unit 108.

The selection unit 105 then reads the feature vector set BG, the quality label set CG, and the non-quality label sets NG corresponding to the non-quality labels of all types stored in the storage unit 102, and feeds the read data to the non-quality-label clustering unit 107 (step S23).

The non-quality-label clustering unit 107 then selects a non-quality label set NG corresponding to one type of non-quality labels not yet subjected to clustering out of the non-quality label sets NG received from the selection unit 105 (step S24).

The non-quality-label clustering unit 107 then divides the feature vector set BG fed from the selection unit 105 into subsets for the respective elements of the non-quality label indicated by the selected non-quality label set NG, and executes clustering on each divided subset (step S25).

The non-quality-label clustering unit 107 then compares the quality determination result by the clustering executed in step S12 with the inspection result indicated by the quality label set CG, calculates the clustering accuracies for the respective subsets, and calculates the average value or the average clustering accuracy (step S26). The calculated average clustering accuracy is reported to the processing unit 108 together with the non-quality label type.

The non-quality-label clustering unit 107 then determines whether or not the non-quality label sets NG corresponding to the non-quality labels of all types have been subjected to clustering (step S27). If the non-quality label sets NG of all types have been subjected to clustering (Yes in step S27), the processing proceeds to step S28, and if there are non-quality label sets NG of any type that have not yet been subjected to clustering (No in step S27), the processing returns to step S24.

The processing unit 108 then subtracts the clustering accuracy calculated by the quality-label clustering unit 106 from each of the average clustering accuracies of the non-quality labels of all types calculated by the non-quality-label clustering unit 107 to calculate an improvement amount of the clustering accuracy for each non-quality label type.

The processing unit 108 then generates an accuracy-improvement-amount screen image indicating at least one non-quality label type and the accuracy improvement amount calculated correspondingly.

The display unit 109 then displays the accuracy-improvement-amount screen image generated by the processing unit 108 (step S30).

Note that, in FIG. 7, steps S20 to S22 of the processing and steps S23 to S27 of the processing may be performed in parallel.

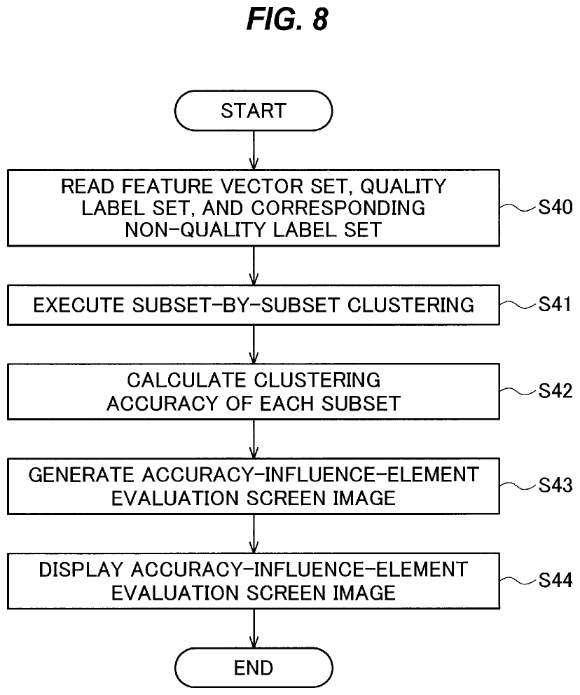

FIG. 8 is a flowchart illustrating the processing by the information processing apparatus 100 to display an accuracy-influence-element evaluation screen image.

The flowchart illustrated in FIG. 8 starts, for example, when an operator of the information processing apparatus 100 inputs an instruction to the input unit 104 to select the accuracy-influence-element evaluation mode. In such a case, the input unit 104 notifies the selection unit 105 and the processing unit 108 that the accuracy-influence-element evaluation mode has been selected.

First, the selection unit 105 reads the feature vector set BG, the quality label set CG, and the non-quality label set NG corresponding to the type selected by the input unit 104 from the storage unit 102, and feeds the read data to the non-quality-label clustering unit 107 (step S40).

The non-quality-label clustering unit 107 then divides the feature vector set BG fed from the selection unit 105 into subsets for the respective elements of the non-quality label indicated by the non-quality label set NG, and executes clustering on each divided subset (step S41).

The non-quality-label clustering unit 107 then compares the quality determination result by the clustering executed in step S41 with the inspection result indicated by the quality label set CG, and calculates the clustering accuracy for each subset (step S42). The clustering accuracy calculated for each subset calculated here is fed to the processing unit 108.

The processing unit 108 then generates an accuracy-influence-element evaluation screen image indicating at least one of the corresponding elements, together with its clustering accuracy, in an ascending order of clustering accuracy for the respective subsets of one non-quality label type calculated by the non-quality-label clustering unit 107 (step S43).

The display unit 109 then displays the accuracy-influence-element evaluation screen image generated by the processing unit 108 (step S44).

According to the embodiments described above, a screen image indicating at least one non-quality label type or element that adversely affects the quality of the digital data DD can be generated and displayed.

In the embodiment described above, the processing unit 108 uses multiple average clustering accuracies to generate a label-type evaluation screen image as a screen image that enables identification of at least one non-quality label type that adversely affects the quality of the multiple pieces of digital data DD. In the label-type evaluation mode, the label-type evaluation screen image displays at least some of the non-quality label types in a descending order of average clustering accuracy, together with their average clustering accuracies. However, the embodiments are not limited to such an example.

For example, the processing unit 108 may generate a label-type evaluation screen image indicating at least one of multiple types in a descending order of multiple variances.

In such a case, the non-quality-label clustering unit 107 may calculate the variance in the clustering accuracy for each subset calculated as described above for each non-quality label type.

By displaying the variances of the clustering accuracies of the respective non-quality labels, non-quality labels having high variation in clustering accuracy can be identified for each element. By adjusting how non-quality labels having high variation are inspected, the quality of the digital data DD can be enhanced.

### DESCRIPTION OF REFERENCE CHARACTERS

100 information processing apparatus; 101 communication unit; 102 storage unit; 103 feature extraction unit; 104 input unit; 105 selection unit; 106 quality-label clustering unit; 107 non-quality-label clustering unit; 108 processing unit; 109 display unit.

What is claimed is:

1. An information processing apparatus comprising:
a storage device to store:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target; and
processing circuitry
to calculate an average clustering accuracy of each of the non-quality label sets to calculate a plurality of the average clustering accuracies corresponding to the non-quality label sets, the average clustering accuracy being an average value of a clustering accuracy of clustering performed on a subset by using the quality label set, the subset being obtained by dividing the feature vectors by each of multiple elements indicated by the respective non-quality labels; and
to generate a screen image enabling identification of at least one non-quality label type adversely affecting quality of the multiple pieces of digital data by using the average clustering accuracies.

2. The information processing apparatus according to claim 1, wherein the processing circuitry generates, as the screen image, a label-type evaluation screen image indicating at least one of the non-quality label types in a descending order of the average clustering accuracies.

3. The information processing apparatus according to claim 1, wherein the processing circuitry
to calculate a reference clustering accuracy, the reference clustering accuracy being a clustering accuracy of clustering performed on the feature vectors by using the quality label set,
to calculate a plurality of improvement amounts by subtracting the reference clustering accuracy from the respective average clustering accuracies, and
to generate, as the screen image, an accuracy-improvement-amount screen image indicating at least one of the non-quality label types in a descending order of the improvement amounts together with the corresponding improvement amount.

4. The information processing apparatus according to claim 1, wherein the clustering accuracy is a success rate of clustering or a failure rate of clustering.

5. The information processing apparatus according to claim 1, further comprising:
a display device to display the screen image.

6. An information processing apparatus comprising:
a storage device to store:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target; and
processing circuitry
to calculate, for a non-quality label set corresponding to non-quality labels of one type selected from the plurality of non-quality labels, a clustering accuracy of clustering performed on a subset by using the quality label set to calculate a plurality of the clustering accuracies, the subset being obtained by dividing the feature vectors by each of multiple elements indicated by the non-quality labels; and
to generate a screen image enabling identification of at least one of the elements adversely affecting quality of the multiple pieces of digital data by using the clustering accuracies.

7. The information processing apparatus according to claim 6, wherein the processing circuitry generates, as the screen image, an accuracy-influence-element evaluation screen image indicating at least one of the elements in an ascending order of the clustering accuracies.

8. The information processing apparatus according to claim 6, wherein the clustering accuracy is a success rate of clustering or a failure rate of clustering.

9. The information processing apparatus according to claim 6, further comprising:
a display device configured to display the screen image.

10. An information processing apparatus comprising:
a storage device to store:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target; and
processing circuitry to calculate, for each of the non-quality label sets, variance of a clustering accuracy of clustering performed on a subset by using the quality label set to calculate a plurality of the variances corresponding to the non-quality label sets, the subset being obtained by dividing the feature vectors by each of multiple elements indicated by the non-quality labels; and
to generate a screen image enabling identification of at least one non-quality label type adversely affecting quality of the multiple pieces of digital data by using the variances.

11. The information processing apparatus according to claim 10, wherein the processing circuitry generates, as the screen image, a label-type evaluation screen image indicating at least one of the non-quality label types in a descending order of the variances.

12. The information processing apparatus according to claim 10, wherein the clustering accuracy is a success rate of clustering or a failure rate of clustering.

13. The information processing apparatus according to claim 10, further comprising:
a display device to display the screen image.

14. A non-transitory computer-readable storage medium storing a program that causes a computer to execute processing comprising:
storing:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target;
calculating an average clustering accuracy of each of the non-quality label sets to calculate a plurality of the average clustering accuracies corresponding to the non-quality label sets, the average clustering accuracy being an average value of a clustering accuracy of clustering performed on a subset by using the quality label set, the subset being obtained by dividing the feature vectors by each of multiple elements indicated by the respective non-quality labels; and
generating a screen image enabling identification of at least one non-quality label type adversely affecting quality of the multiple pieces of digital data by using the average clustering accuracies.

15. A non-transitory computer-readable storage medium storing a program that causes a computer to execute processing comprising:
storing:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target;
calculating, for a non-quality label set corresponding to non-quality labels of one type selected from the plurality of non-quality labels, a clustering accuracy of clustering performed on a subset by using the quality label set to calculate a plurality of the clustering accuracies, the subset being obtained by dividing the feature vectors by each of multiple elements indicated by the non-quality labels; and
generating a screen image enabling identification of at least one of the elements adversely affecting quality of the multiple pieces of digital data by using the clustering accuracies.

16. A non-transitory computer-readable storage medium storing a program that causes a computer to execute processing comprising:
storing:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target;
calculating, for each of the non-quality label sets, variance of a clustering accuracy of clustering performed on a subset by using the quality label set to calculate a plurality of the variances corresponding to the non-quality label sets, the subset being obtained by dividing the feature vectors by each of multiple elements indicated by the non-quality labels; and
generating a screen image enabling identification of at least one non-quality label type adversely affecting quality of the multiple pieces of digital data by using the variances.

17. An information processing method comprising:
storing:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target;
calculating an average clustering accuracy of each of the non-quality label sets to calculate a plurality of the average clustering accuracies corresponding to the non-quality label sets, the average clustering accuracy being an average value of a clustering accuracy of clustering performed on a subset by using the quality label set, the subset being obtained by dividing the feature vectors by each of multiple elements indicated by the respective non-quality labels; and
generating a screen image enabling identification of at least one non-quality label type adversely affecting quality of the multiple pieces of digital data by using the average clustering accuracies.

18. An information processing method comprising:
storing:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target;
calculating, for a non-quality label set corresponding to non-quality labels of one type selected from the plurality of non-quality labels, a clustering accuracy of clustering performed on a subset by using the quality label set to calculate a plurality of the clustering accuracies, the subset being obtained by dividing the feature vectors by each of multiple elements indicated by the non-quality labels; and
generating a screen image enabling identification of at least one of the elements adversely affecting quality of the multiple pieces of digital data by using the clustering accuracies.

19. An information processing method comprising the steps of:
storing:
a feature vector set including a plurality of feature vectors generated by extracting a predetermined feature from each of multiple pieces of digital data indicating measurement values obtained by measuring a target;
a quality label set including a plurality of quality labels corresponding to the multiple pieces of digital data and indicating quality of the target; and
a plurality of non-quality label sets each including a plurality of non-quality labels, the non-quality labels corresponding to the multiple pieces of digital data and being of a type expected to be independent of the quality of the target;
calculating, for each of the non-quality label sets, variance of a clustering accuracy of clustering performed on a subset by using the quality label set to calculate a plurality of the variances corresponding to the non-quality label sets, the subset being obtained by dividing the feature vectors by each of multiple elements indicated by the non-quality labels; and
generating a screen image enabling identification of at least one non-quality label type adversely affecting quality of the multiple pieces of digital data by using the variances.
